(19) United States
(12) Patent Application Publication
(10) Pub. No.: US 2017/0291496 A1
(43) Pub. Date: Oct. 12, 2017

(54) Automatic, dual power, inductive and conductive charger for electric cars.

(71) Applicants: Sten R. Gerfast, Mendota Heights, MN (US); Aric Rasmussen, Spring Valley, WI (US)

(72) Inventors: Sten R. Gerfast, Mendota Heights, MN (US); Aric Rasmussen, Spring Valley, WI (US)

(21) Appl. No.: 14/999,183

(22) Filed: Apr. 9, 2016

(51) Int. Cl. B60L 11/18

(52) U.S. Cl. CPC B60L 11/182; B60L 11/1829; B60L 11/1835

(57) ABSTRACT

Automatic, dual power, inductive and electrical, vehicle charge station. This invention is a convenient, automatic, electric vehicle charge station, where the driver does nothing except driving in. It can have two charge methods:

A. Electrical conductive power with magnetic attractive closure in the charge station, for efficient dual contact transfer of either AC or DC to a vehicle.

B. Inductive power transfer with mating primary and secondary inductors that inductively transfers power to a vehicle by a transportable charge station.

For safety, the charge station has unique E-type laminations located front-to front, unique self releasing electrical contacts, and unique, self closing, safety sleeves in case of angry driver drive-off. No damage to vehicle or station.

Many different systems are described for guidance of the vehicle into the charge station.

This application claims the benefit of U.S. Provisional Application No. 62/230,525 filed on Jun. 9, 2015, with the same inventors.

### BRIEF SUMMARY OF THE INVENTION

This invention is for a convenient, automatic, electric vehicle charge facility station.

The charge station is having AC or DC powered electrical connectors automatically being coupled with receiving type electrical connector in a vehicle, using inductive magnetic attraction for this mechanical coupling, thereby transferring electric conductive power to the vehicle automatically.

Additionally, an alternate charge method is having mating primary and secondary inductors that inductively transfers AC power from a transportable primary charger to a secondary inductor in a vehicle.

When the primary is energized, it is magnetically attracting the secondary. This attraction occurs with either AC or DC. If either the primary or secondary is movable by a gimbal mount or suspension it will be closing their distance until both are touching, and locks together magnetically, thereby transferring electric inductive power to the vehicle automatically.

The user of this charge station is provided with maximum convenience, without having to attach or manipulate anything in the charge facility.

### BRIEF DESCRIPTION OF THE INVENTION

Convenience is requested by many customers in the market place today.

Persons that own electric vehicles today, would also like to have a convenient way of charging their battery in their vehicle. With the fast pace of the modem life today, it is also natural for them to combine a battery charge with a stop, while they are having breakfast, lunch or dinner, either in a curb service or sit down arrangement.

Or combining their entertainment or a service appointment with a fill up of their battery.

With more and more electric vehicles on the road this invention responds to both the above mentioned needs. plus all the other needs in the future where this charge station is perfect for Automatic charging of cars, trucks, motor cycles, golf carts, all terrain vehicles and garden and farm tractors.

The driver only needs to drive in to the charge station, which notices the license plate and perhaps even have the owners credit card on file, to automatically get a charge.

This is without the driver having to attach or manipulate anything in the charge station.

### BRIEF DESCRIPTION OF THE DRAWINGS

FIG. 1 is a charge station showing a vehicle and guide rails for guiding the vehicle to a charge station, and is also showing the station in proximity to the vehicle.

A charge module is shown just below the license plate. A primary inductor is at the same height as the charge module. Also shown is an adjacent building

In FIG. 2 is shown the electric, conductive type of charging.

It is a view of two inductor using E-type lamination located in the unique position of one E-type facing the second E-type front-to -front for excellent magnetic and attractive efficiency.

A plurality of heavy duty contacts on the primary inductor is having mating heavy duty spring loaded contacts on the secondary, for low omhic resistance.

In FIG. 3 is shown the inductive, two inductor type of charging.

It is a view of two inductor using E-type lamination located in the unique position of one E-type facing the second E-type front-to -front for excellent both magnetic and attractive efficiency.

When in the closed-together charging mode the excellent front, smooth surfaces of both inductors, locates them for the best quality inductive transfer charging.

In FIG. 4 is shown a unique self closing safety sleeve for contact points that are attached to a wire. It has a hinge on the top with a central section wherein the contacting point is located, and curved angular legs for opening.

FIG. 5 is showing how the primary and the secondary in the vehicle is meeting together before the charging. The primary is pivoted, to be folded down in case of an emergency, or angry driver drive off. The folding of the primary can be used in a drive-in-drive-out type, rather then drive-in back-out.

FIG. 6 is showing the charge module with its waterproof doors open.

It is placed below the vehicle's standard type license plate.

In FIG. 7 is shown a prior art condition where the driver drove off without dis-connecting the prior art type, electrical cable and the damage it caused.

In FIG. 8 is shown a second aligning method using a conical part aligned with a conical cavity, with attraction between the two parts provided with an electro magnetic coil.

### DETAILED DESCRIPTION OF THE DRAWINGS

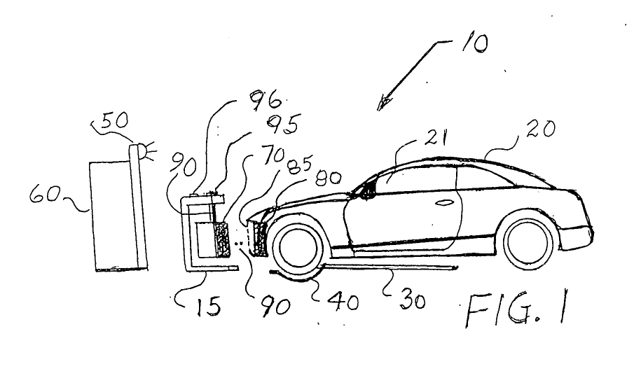

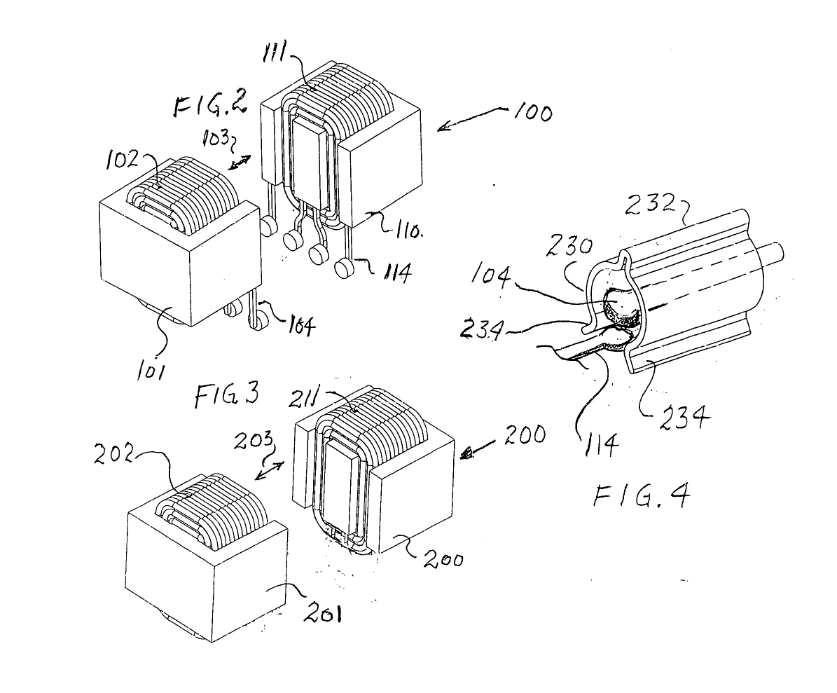

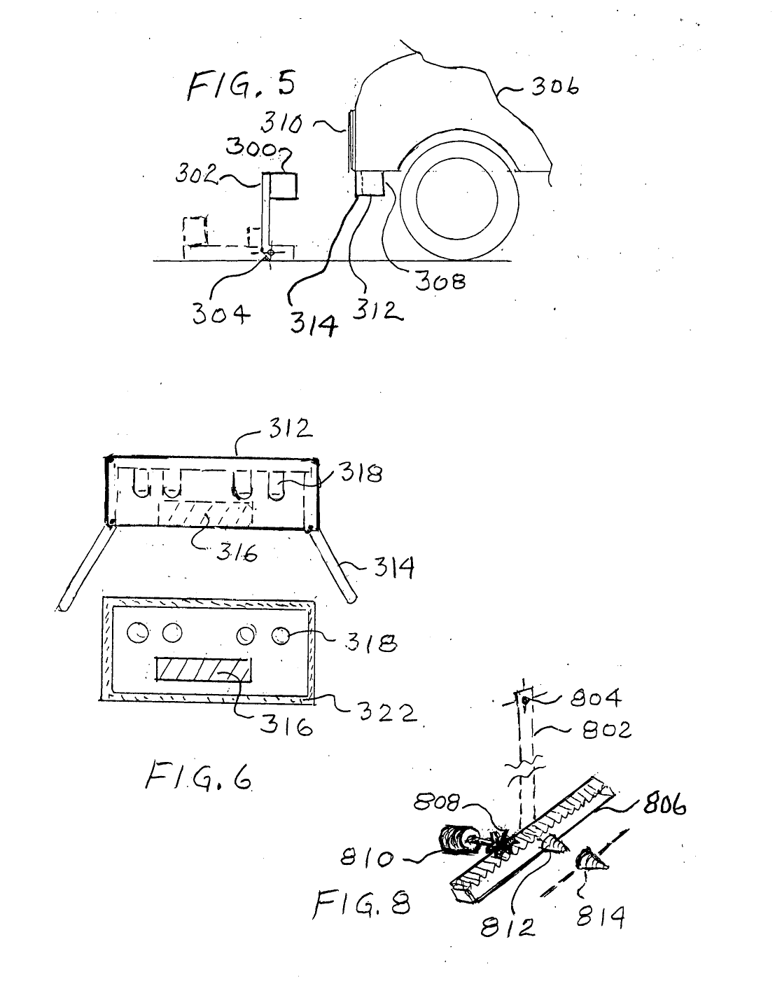

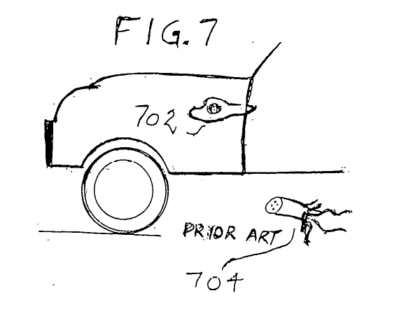

FIG. 1 is a charge facility 10 with a charge station 15 and with a vehicle 20 with a driver 21 moving towards the charge station 15. Also shown are guide rails 30 for guiding the vehicle into the facility 10, and a depression 40 which provides the vehicle 20 a first reference point for charging. The vehicle 20 is shown further away from the charge station, then is normal, in this view.

A signal 50 on a building 60 is indicating when the vehicle 20 has reached the depression 40. A first inductor 70 in the charge station 15 is in close proximity to the second inductor 80 in the front end of the vehicle 20, having a driver 21 moving the vehicle towards the first inductor. Magnetic attraction 90 occurs between the first 70 and second inductor 80 to provide for coupling between the two. Doors 85 are opened automatically, when the second inductor 80 is approaching. The first inductor 70 has an up-down lifter 95 either hand operated or motor operated 96.

First inductor 70 is suspended 90 from stand 15 in a “drive-in back-out” type charger.

The above description can of course also be descriptive of other arrangements described elsewhere in this specification.

In FIG. 2 is shown 100, the electric, conductive type of charging.

It is a view of two inductors, 101 and 110 using E-type laminations located in the unique position of one E-type 101 facing the second E-type 110 front-to -front for excellent magnetic and attractive efficiency.

Inductor 101 has windings 102 creating a magnetic attractive force 103 that attracts inductor 110 for magnetic coupling between inductor 101 and inductor 110. Inductor 110 can also have windings 111, if a stronger attractive force between the inductor 101 and inductor 110 is required.

Inductor 101 is having a plurality of contacts 104 that in the shown open position carries no current. In the charging position, Inductor 101 after being closely attracted to inductor 110, carries high current in its contacts 104 into mating type plurality of contacts 114.

Contacts 104 and contacts 114 are spring loaded together 110 for excellent transfer of the high charging current, with low ohms. The physical design of the two set of contacts are uniquely spring loaded together by the said magnetic attractive force 103.

The plurality of contacts 104 and 114 can be used for either DC or AC current.

The physical spacing of the contacts 104 and 114 are conforming to the spacing required by North American, European and Asian standards for high current and for high voltage.

Again it should be mentioned that the unique positioning of one E-type 101 facing the second E-type 110 front-to -front, gives both excellent inductive efficiency and excellent magnetic attractive efficiency.

The “normal” positioning of E-frames, one E facing left, with the next E facing right, and repeat, does not give attractive properties, nor does it give the very good induction qualities desired in this invention.

It could again be mentioned that the spring-loaded very good, low omhic conductivity between contact 104 and 114 is achieved uniquely by magnetic attraction.

In FIG. 3, shown as charging type 200, is the inductive, two inductor type of charging.

It is a view of two inductors 201 and 210 using E-type lamination located in the unique position of one E-type facing the second E-type front-to -front for excellent both magnetic and attractive efficiency.

When in the closed-together charging mode the excellent front, smooth surfaces of both inductors 201 and 210, locates them for the best quality inductive transfer charging.

The first Inductor 201 have windings 202 creating magnetic induction, and magnetic attraction 203 between inductor 201 and inductor 210.

The magnetic induction from inductor 201 creates an inductive current into the windings 211 on inductor 210 when the attractive force 203 have closed the spacing between inductor 201 and inductor 211.

After the winding 202 have been energized, excellent inductive power are transferred between inductor 201 and inductor 210.

The above mentioned unique positioning of one E-type 201 facing the second E-type 210 front-to -front, also gives additional efficiency, in the transfer into the induction winding 211 on inductor 210

In FIG. 4 is shown a unique self-closing safety sleeve 230 that can be used on any contacts but are specifically suited for the contacts 104 and 114 in FIG. 2. The sleeve is shown in the open position with a top contact touching a lower contact

This self-closing sleeve 230 is made from plastic or elastomeric material with a hinge 232 (living hinge) on the top side, a cylindrical center section, and a lower section having two angular legs 234, which during contacting operation, opens up to allow high current to flow from the contact 104 inside the sleeve which it is pressed against a secondary connector 114 to make a very good electrical low ohm connection. The pressing of the contacts 104 and 114 against each other are done with a magnetic force, to be both constant and spring loaded.

FIG. 5 is showing how the primary inductor 300 is mounted on a stand 302 having a pivot point 304. A vehicle 306 is having a secondary inductor 308 mounted on the vehicle 306 below the ordinary license plate 310, with the secondary inductor 308 mounted further back then the license plate 310. The secondary inductor 308 is in an charge module 312 having water proof doors 314, with the charge module shown in the closed position.

The secondary inductor 308 in the vehicle 306 is lined up with the primary inductor 300 on the stand 302.

Above the secondary inductor 308 is shown the standard vehicle front license plate 310, which is commonly mounted centered on vehicles in North America, Europe and Asia. This type of license plate is also having common dimensional standard in most countries.

When the vehicle 306 is approaching the primary inductor 300 the waterproof doors 314 open to expose the secondary inductor 308.

During further movement of the vehicle 306, magnetic attraction, 103 or 203, securely couples the primary 300 inductor together with the secondary inductor 308. After the coupling, an automatic switch (not shown) energizes either, the contacts 104 and 114 shown in Fig, 2, or the windings 202 shown in FIG. 3. The contacts 104 and 114 energizes the conductive type charging and in stead, if the winding 202 are energized, the charge station performs inductive type charging.

FIG. 6 is showing a front and top view of the enclosed charge module 312 having a ferro magnetic part 316 and a plurality of contacts 318 which receive high current from contacts inside the primary 300. The waterproof doors 314 are shown in the open position, where they have a secondary function by mechanically guide the first conductor 300 towards the secondary conductor 312.

Water proofing strips 320 are shown on the front view as 322 for the doors 314.

In FIG. 7 is shown in a prior art condition how badly a prior art vehicle 700 can be damaged if a drive-off condition occurs. Prior art vehicles 700 normally have heavy plug-in cables which are hand-inserted in to an opening for the heavy cable, also called “plug-in- openings”. Fig, 7 shows the severe damage 702 that can occur on the vehicle 700 itself, the torn plug-in cable 704, as well as the tower (not shown) where the cable is normally connected to heavy current.

This current in the torn cable can be electro-cuting, or cause fires.

The drive-off condition described above sometimes is sometimes accidental or it can be a so called “angry-Driver-drive-off”

In FIG. 8 is showing how in the present invention further mechanical guidance can be done between the first inductor 300 and the second inductor 308.

A support member 802 is pivoted from a pivot point 804 carrying a gear rack 806 engaged with a gear 808 in which the gear 808 can move the gear rack 806 side to side.

The gear is driven by a motor 810 which can by switches (not shown) be commanded to move a conical part 812 into a desired position to line up with a conical cavity 814. The part 812 or part 814 can be mounted on the first inductor 300 or the second inductor 308, or vice versa for another method of alignment in this invention.

The above descriptions does anticipate that a person skilled in the art would sketch out similar sketches,but he or she would find many of the described features in this invention to be unique.

1. Automatic, dual power, inductive and conductive charge station comprising:
a charge station having a plurality of AC and DC powered electrical conductors, adjacent an energized first inductor, a second inductor located in an adjacent vehicle, having mating type electrical conductors,
wherein inductive magnetic attraction between first and second inductor automatically gets spring loaded contact coupling by magnetic attraction between the powered conductors and the mating type conductors in the vehicle, thereby transferring electrical conductive power to the vehicle.

2. Automatic, dual power, inductive and conductive charge station comprising:
a vehicle charge station having a fixed primary inductor with a plurality of windings energized with AC, a movable secondary inductor in an adjacent vehicle, with the secondary inductor having a similar plurality of windings, enclosed in charge module, with the secondary non-energized inductor moved by the vehicle into close proximity to the first inductor, after which the energizing magnetically attracts and locks the two inductors together, achieving energy efficient inductive power transfer from primary to secondary inductor.

3. Automatic, dual power, inductive and conductive charge station comprising:
a vehicle charge station having a fixed primary inductor with a plurality of windings, energized with AC, a movable secondary inductor in an adjacent vehicle, with the secondary inductor having a similar plurality of windings, with the secondary non-energized inductor in the vehicle, driven by a driver who is moving the vehicle into close proximity to the first inductor, after which the energizing magnetically attracts and locks the two inductors together, thereby, without any further action by the driver, is achieving energy efficient inductive power transfer from primary to secondary inductor.

4. Automatic, dual power charge station according to claim 1,
wherein high ampere spring loaded contacts are designed to rapidly disconnect, and automatically be covered by self closing safety sleeves, and with the charge station designed to be instantly lowered below the normal charge stations height, if an “angry driver drive-off” occurs.

5. Automatic, dual power charge station comprising according to claim 1
wherein the mating electrical conductors in the vehicle are enclosed by two waterproof doors, motorized to automatically open and close,
wherein the open angular position of the doors also provide mechanical guidance for mating of first and second inductors.

6. Dual power, inductive and conductive, charge station according to claim 2
wherein the movement of the vehicle into close proximity to the primary inductor is guided by a beam of a laser or LED light emitted by the station, received and translated into motorized vehicle motion.

7. Dual power, inductive and conductive, charge station according to claim 6
wherein the movement of the vehicle into close proximity to the primary inductor is guided by “global positioning system” (GPS) into the location of both the primary and secondary, received and translated into motorized vehicle motion, and the vehicle is “driver-less”.

8. Dual power, inductive and conductive, charge station according to claim 1.
wherein the primary inductor or secondary inductor is fixed to a gimbal mount allowing north-south and east-west motion, and an up-down motion using a hand or a motor-adjustable treaded rod, allowing for pre-programmable inductor location, by vehicle size, received and translated into motorized charge station motion.

9. (canceled)

10. Dual power, charge station according to claim 1
wherein the charger station is available in 3 version: A a simple home and garage type with no up-down adjustment, inexpensive enough, and small enough to carry in the drivers trunk, with plug-in means into a business outlet, B same but with up-down adjustment, C a store type version with license plate reader and “customer credit card information on file” with up-down adjustment.

11. (canceled)

12. Automatic, dual power, charge station according to claim 2 having a charge module wherein all the vehicle components are enclosed in a waterproof module having a plurality of waterproof doors, operated for opening and closing, using an electric motor.

13. Automatic, dual power, charge station according to claim 1
wherein both the first and second inductors are using E-type laminations with one E-type facing forwards and locks with the other E-type facing backwards and both E-types are wound with magnet wire.

14. (canceled)

15. Automatic, dual power, charge station according to claim 2
wherein the charge station is suitable for charging electric cars, trucks, motor cycles, golf carts, all terrain vehicles, garden and farm tractors.

16. Automatic, dual power, charge station according to claim 2 wherein the primary and secondary inductors are inductively transferring AC power for 120, 240, 430 volts having a frequency of 60 Hz, 50 Hz, 400 Hz or higher frequencies.
